(19) United States
(12) Patent Application Publication
(10) Pub. No.: US 2013/0326404 A1
(43) Pub. Date: Dec. 5, 2013

(54) Disable Feature of Computing Device

(71) Applicants: Robert C. Brooks, Houston, TX (US); Timothy J. Freese, Niwot, CO (US)

(72) Inventors: Robert C. Brooks, Houston, TX (US); Timothy J. Freese, Niwot, CO (US)

(21) Appl. No.: 13/484,265

(22) Filed: May 30, 2012

(51) Int. Cl. G06F 9/00; G06F 3/048

(52) U.S. Cl. 715/810; 713/100; 713/2

(57) ABSTRACT

A computing device to detect if a power button of the computing device is accessed as computing device initially receives power from a power source. The computing device disables a feature of the computing device if the power button is accessed as the computing device initially receives power from the power source.

### BACKGROUND

When accessing special features of a computing device, a user can initially power the computing device on. As the computing device powers on, a basic input/output system (BIOS) and an operating system of the computing device is launched. Once the BIOS and operating system are launched, the user can use an input component of the computing device to access one or more settings of the BIOS and/or operating system to disable features of the computing device.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a computing device with a power button, a power component, and a power logic module according to an example.

FIG. 2 illustrates a power component of a computing device to couple with a power source according to an example.

FIG. 3 illustrates a block diagram of a power application disabling a feature of a computing device according to an example.

FIG. 4 is a flow chart illustrating a method for managing features of a computing device according to an example.

FIG. 5 is a flow chart illustrating a method for managing features of a computing device according to an example.

### DETAILED DESCRIPTION

A computing device includes a power component to couple with a power source and receive power for the computing device. For the purposes of this application, a power component can be a hardware component, such as a power supply, which can receive power for components of the computing device. The power component can determine if power is initially being received from the power source. Power is initially being received by the power component if the power source couples to the power component from a decoupled state. The power source can be a wall outlet, a battery component, and/or any additional device which can supply power to the computing device.

If power is initially being received form the power source, the computing device can detect if a power button is being accessed as the power component initially receives power. The power button is a hardware and/or mechanical component which can be accessed by a user to turn on the computing device. If the computing device detects the power button being accessed as the power component initially receives power, the computing device can proceed to disable a feature of the computing device. In one embodiment, the feature can be disabled before a Basic Input/Output System (BIOS) and/or operating system of the computing device are launched.

A feature of the computing device can include a mode of operation, a setting, a service, an application, and/or a component of the computing device. For example, the feature can be a power mode of the computing device. In some instances, a feature can be incompatible and/or corrupt. The incompatible and/or corrupt feature restricting the BIOS and/or operating system from completely launching. By disabling the feature, the BIOS and/or operating system can properly launch without the feature. As a result, a user of the computing device can continue to use the computing device without the feature,

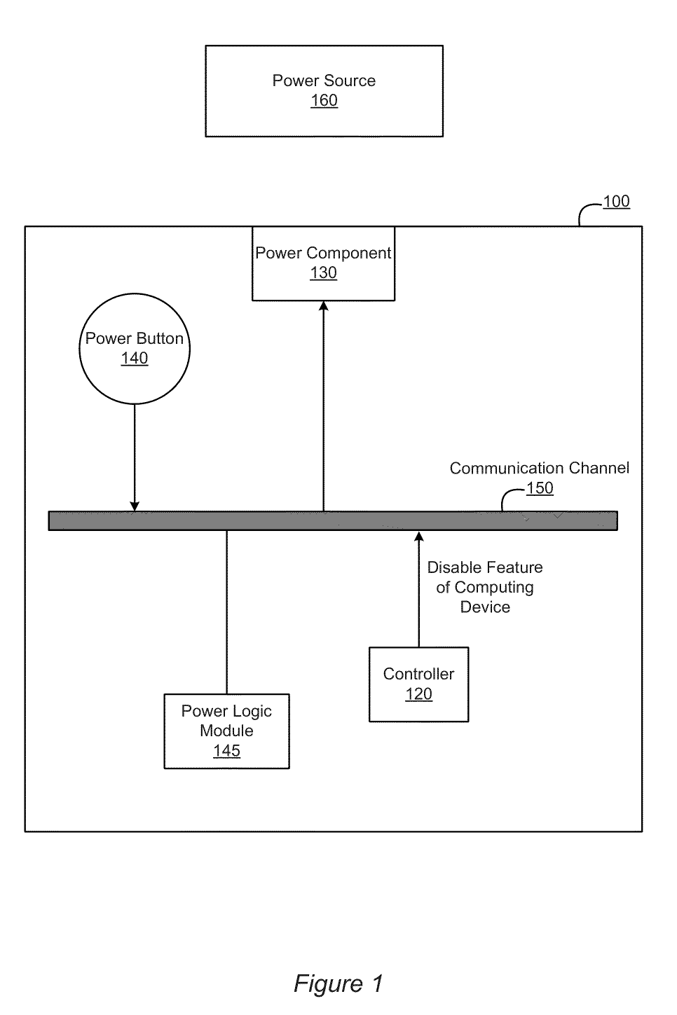

FIG. 1 illustrates a computing device 100 with a power button 140, a power component 130, and a power logic module 145 according to an example. In one embodiment, the computing device 100 can be a desktop, a laptop, a notebook, a tablet, a netbook, an all-in-one system, and/or a server. In another embodiment, the computing device 100 can be a cellular device, a PDA (Personal Digital Assistant), an E (Electronic)-Reader, a tablet, a camera, and/or any additional device which can couple with a power source 160.

The computing device 100 includes a controller 120, a power component 130, a power button 140, a power logic module 145, and a communication channel 150 for the computing device 100 and/or one or more components of the device 100 to communicate with one another. In one embodiment, the computing device 100 also includes a power application stored on a non-volatile computer readable medium included in or accessible to the computing device 100. For the purposes of this application, the power application is an application which can be utilized independently and/or in conjunction with the controller 120 to manage features of the computing device 100.

A feature of the computing device 100 can be a service, an application, a firmware, a setting, a driver, a component, and/or a mode of operation of the computing device 100. In one embodiment, a feature can be a power mode of the computing device 100. The computing device 100 can include one or more features which can be launched with a Basic Input/Output System (BIOS) and/or an operating system of the computing device 100. The power component 130 can detect for power being initially received from the power source 160. For the purposes of this application, power is initially received from the power source 160 if the power component 130 couples to the power source 160 from a decoupled state. The power component 130 is decoupled from the power source 160 if the power component 130 is not electrically coupled to the power source 160. If the power component 130 is not electrically coupled to the power source 160, the power component 130 does not receive any power.

The power component 130 is a hardware component of the computing device 100 which can receive and manage power received from the power source 160. In one embodiment, the power component 130 is a power supply of the computing device 100. The power component 130 can include an interface port to couple with the power source 160 to receive the power. The power source 160 is device, such as a power wall outlet, a battery, and/or any additional device which can supply power to the power component 130 as an alternating current and/or as a direct current.

If power is initially received from the power source 160, a power logic module 145 can detect if a power button 140 of the computing device 100 is accessed as the power component 130 initially receives power. For the purposes of this application, the power logic module 145 is a hardware and/or software component which is coupled to the power component 130 and the power button 145. The power logic module 145 determines when the power component 130 is receiving power and if the power button 140 is being accessed. The controller 120 and/or the power application can poll the power logic module 145 to determine if the power button 140 is being accessed while the power component 130 initially receives power.

If the power button 140 is being accessed as power is initially being received by the power component 130, the controller 120 and/or the power application proceed to disable a feature of the computing device 100. When disabling a feature, the controller 120 and/or the power application can halt a boot process of the computing device 100 before a basic input/output system (BIOS) and/or an operating system of the computing device 100 is loaded. In one embodiment, before the BIOS and/or the operating system are launched, the controller 120 and/or the power application can intercept and disable the feature before it is launched with the BIOS and/or operating system.

In another embodiment, the controller 120 and/or the power application can access a features list. The features list can include features of the computing device 100 which are launched with the BIOS and/or the operating system. The controller 120 and/or the power application can remove a feature from the features list, such that it is not launched along with the BIOS and/or the operating system. The disabled feature can be or include a power mode, an application, a service, a firmware, a driver, and/or a component of the computing device 100. Once the feature has been disabled, the controller 120 and/or the power application proceed to launch the BIOS and/or the operating system without the feature.

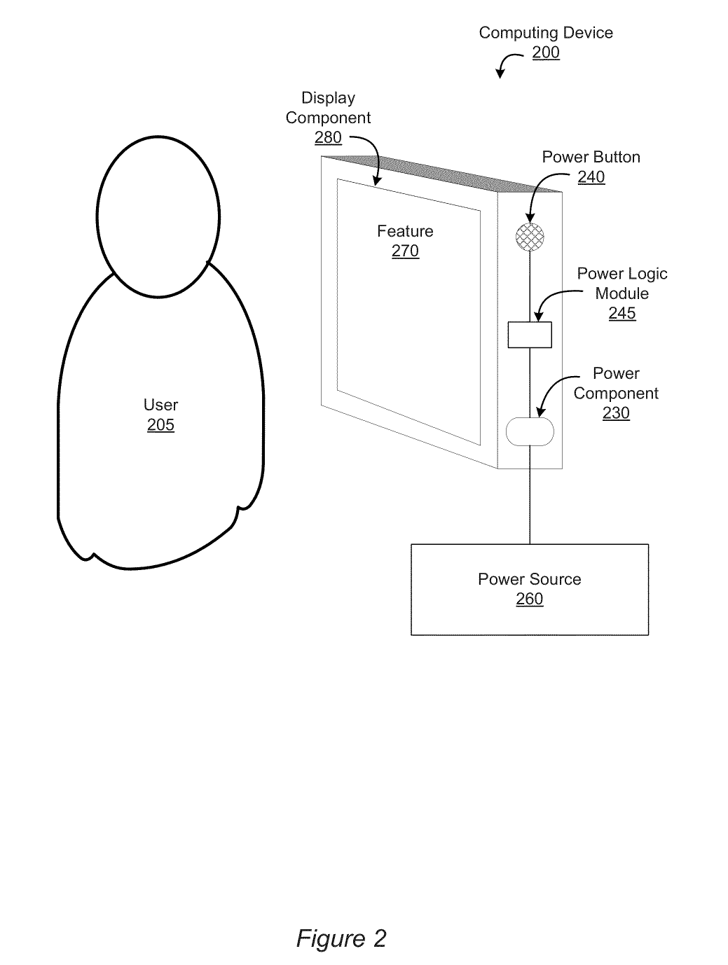

FIG. 2 illustrates a power component 230 of a computing device 200 to couple with a power source 260 according to an example. As noted above, the power component 230 is a hardware component of the computing device 200, such as a power supply which can receive power and manage power supplied to components of the computing device 200. The power component 230 can include an interface port to receive power from a power source 260. The power source 260 can be a battery, powered wall outlet, an inductive charger, and/or any additional device which can supply power to the power component 230. Power can be supplied to the power component 230 as an alternating current and/or a direct current.

The power component 230 can detect if power is initially being received from the power source 260. For the purposes of this application, power is initially being received if the power component 230 couples to the power source 260 from a decoupled state and the power source 260 supplies power to the power component 230. The power component 230 and the power source 260 are in a decoupled state if the power component 230 is not electrically coupled to the power source 260. If the power component 230 is not electrically coupled to the power source 260, the power component 230 does not receive power.

For example, the power component 230 is not electrically coupled to the power source 260 if the interface power of the power component 230 is not physically coupled to the power source 260. In another example, the power component 230 is not electrically coupled to the power source 260 if an inductive charging component of the computing device 200 is not within proximity of the power source 260 to receive power. If the power component 230 couples to the power source 260 from the decoupled state and the power source 260 proceeds to supply power to the power component 230, the power component 230 is determined to initially receive power.

In response to initially receiving power from the power source 260, the power component 230 can notify a power logic module 245 that power is initially being received. For the purposes this application, the power logic module 245 is a hardware and/or software component of the computing device 200. In one embodiment, the power logic module 245 is included as part of the controller of the computing device 200. As shown in FIG. 2, the power logic module 245 is coupled to the power component 230 and a power button 240 of the computing device 200. The power logic module 245 detects for a signal from the power component 230 indicating that power is initially being received from the power source 260. In another embodiment, the power logic module 245 detects for a current and/or a voltage from the power component 230 to determine when the power component 230 is initially receiving power. In response to receiving the signal, the power logic module 245 can determine if the power button 240 is being accessed. In one embodiment, when determining if the power button 240 is being accessed as the power component 230 initially receives power, the power logic module 245 can determine if power is initially being received by the power component 230 while the power button 240 is simultaneously being accessed.

As noted above, the power button 240 is a hardware and/or mechanical component which can be accessed by a user 205 to power on the computing device 200. In one embodiment, the power button 240 can include a mechanical switch which can be pressed by the user 205. In another embodiment, the power button 240 can include a touch sensor which the user 205 can touch. The user 205 can be any person which can access the power button 240 by pressing and/or touching the power button 240 to power on the computing device 200. For the purposes of this application, when powering on, the computing device 200 transitions from a power off state to a power on state. In one embodiment, the power off and power on state can be power states of the advanced configuration and power interface (ACPI) specification. For example, the power off state can include a G3, G2, and/or S5 power state. The power on state can include the G0 or S0 power state,

If the power logic module 245 detects the power button 240 being accessed as the power component 230 initially receives power from the power source 260, the controller and/or the power application can proceed to disable one or more features 270 of the computing device 200, As noted above, a feature 270 of the computing device 200 can be a service, an application, a setting, a firmware, a driver, a component, and/or a mode of operation of the computing device 200. In one example, the feature can be a power mode of the computing device 200. The power mode can be a max power mode which specifies a threshold power level to be received by the power component 230 before the computing device 200 can power on. In response to disabling one or more features, the controller and/or the power application can proceed to launch a BIOS and/or operating system of the computing device 200.

In one embodiment, as shown in FIG. 2, the computing device 200 includes a display component 280. The display component 280 is a hardware output component of the computing device 200 to display a user interface for the user 205 to view and/or interact with. In one embodiment, the display component 280 can be a LCD display, a LED display, a CRT display, a plasma display, a projector, and/or any additional output component to display the user interface. The user interface can include a feature list displaying one or more features 270 of the computing device 200. One of more of the features 270 can be marked as enabled or disabled.

In other embodiments, the computing device 200 can also include an input component for the user 205 to access. The user 205 can utilize the input component to select one or more disabled features 270 on the feature list to re-enable. For the purposes of this application, the input component is a hardware input component which can detect the user 205 selecting one or more features 270 to re-enable. In one embodiment, the input component can be a keyboard, a mouse, and/or a touch pad of the computing device. In another embodiment, the input component can be a touch screen integrated with the display component 270. In response to detecting the user 205 select a feature 270 to re-enable, the controller and/or the power application can proceed to re-enable the selected feature 270. The BIOS and/or the operating system can then be launched with the selected feature 270 re-enabled,

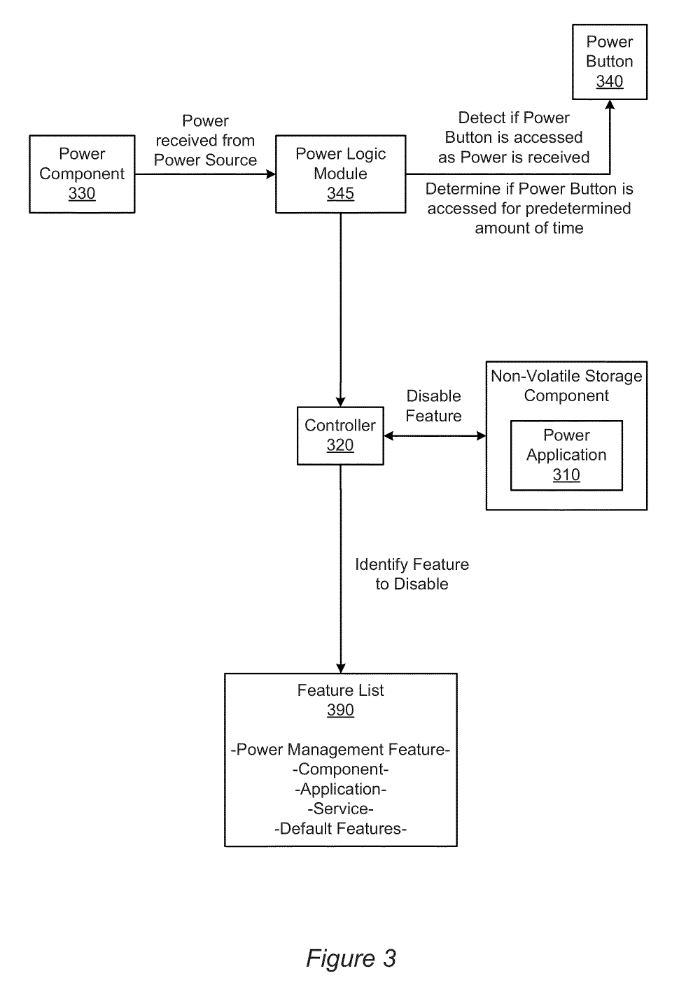

FIG. 3 illustrates a block diagram of a power application disabling a feature of a computing device according to an example. As noted above, the power application 310 can be utilized independently and/or in conjunction with the controller 320 to manage features of the computing device. In one embodiment, the power application 310 can be firmware embedded into one or more components of the computing device. In another embodiment, the power application 310 can be an application accessible from a non-volatile computer readable memory of the computing device. The computer readable memory is a tangible apparatus that contains, stores, communicates, or transports the application for use by or in connection with the device. In one embodiment, the computer readable memory is a hard drive, a compact disc, a flash disk, a network drive or any other tangible apparatus coupled to the computing device.

As shown in FIG. 3, the power component 330 detects power being initially received from a power source. In response, the power logic module 345 proceeds to detect if the power button 340 is being accessed as the power is initially received. In one embodiment, the power logic module 345 also determines if the power button 340 is continuously accessed for a predetermined amount of time. The predetermined amount of time can be defined by the controller 320, the power application 310, and/or by a user of the computing device. For example, the predetermined amount of time can be 3 seconds and be defined by the controller 320. If the power button 340 is accessed for the predetermined amount of time as power is initially received, the power logic module 345 can send a signal to the controller 320 and/or the power application 310. In one embodiment, the signal and/or notification can be an instruction for the controller 320 and/or the power application 310 to disable a feature of the computing device. The controller 320 and/or the power application 310 can then proceed to disable a feature of the computing device. The computing device can include one or more features which can be launched with a BIOS and/or an operating system of the computing device.

When disabling a feature, the controller 320 and/or the power application 310 can initially halt the launching of the BIOS and/or the operating system as the computing device powers on. The controller 320 and/or the power application 310 can intercept the feature and halt or disable the feature before it is launched with the BIOS and/or operating system. In another embodiment, the controller 320 and/or the power application 310 can access a features list 390. The features list 390 can include features of the computing device which are launched with the BIOS and/or the operating system. The controller 320 and/or the power application 310 can remove a feature from the features list 390 such that it is not launched along with the BIOS and/or the operating system.

In one embodiment, the controller 320 and/or the power application 310 can identify and disable non-default features of the computing device. Each feature of the computing device can be marked or classified as a default feature or a non-default feature. A default feature can be a service, an application, a setting, a component, and/or a mode of operation utilized by the BIOS and/or operating system to properly launch. A non-default feature can be non-essential service, application, setting, component, and/or mode of operation which is note necessary for the BIOS and/or the operating system to properly launch.

The controller 320 and/or the power application 310 can access each feature and proceed to disable the non-default features, while enabling the default features. The controller 320 and/or the power application 310 can then launch the BIOS and/or the operating system with the default features enabled and the non-default features disabled. In another embodiment, a user can access an input component to select one or more of the disabled features to re-enable. The controller 320 and/or the power application 310 then launch the BIOS and/or the operating system with the selected feature re-enabled.

The controller 320 and/or the power application 310 can further determine if the BIOS and/or the operating system successfully launch with the re-enabled feature. If the BIOS and/or the operating system do not successfully launch, the controller 320 and/or the power application 310 can launch a diagnostic mode of the computing device. The diagnostic mode can determine if the re-enabled feature and/or any additional enabled feature of the computing device is restricting the BIOS and/or the computing device from properly launching. The diagnostic mode can then disable any feature identified to be restricting the BIOS and/or the operating system from properly launching.

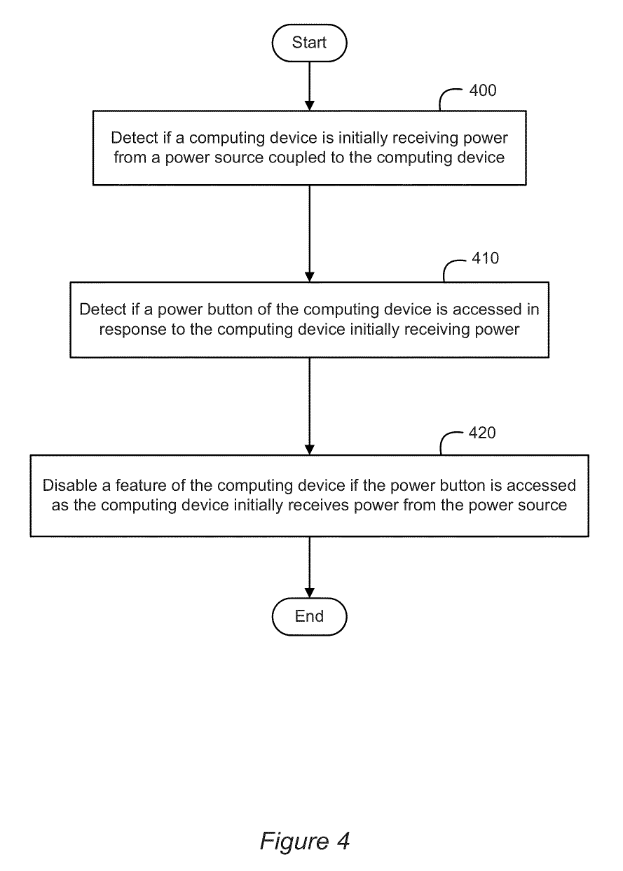

FIG. 4 is a flow chart illustrating a method for managing features of a computing device according to an example. A power component can detect if the computing device is initially receiving power from a power source at 400. The power source can be a wall outlet, a battery, and/or any additional device or component which can supply power to the computing device. If the power component initially detects power from the power source, the controller and/or the power application can detect if a power button of the computing device is being accessed at 410. A user can press or touch the power button when accessing the power button. If the power button is being accessed as the computing device initially receives power, the controller and/or the power application can proceed to disable a feature of the computing device at 420. The method is then complete, In other embodiments, the method of FIG. 4 includes additional steps in addition to and/or in lieu of those depicted in FIG. 4.

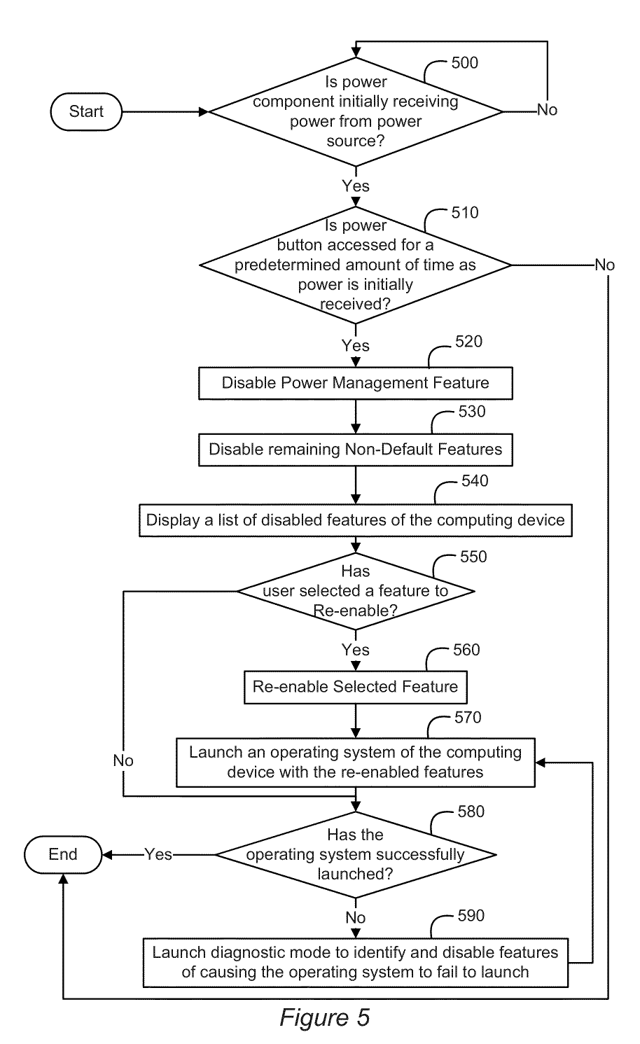

FIG. 5 is a flow chart illustrating a method for managing features of a computing device according to an example. The power component initially detects if power is initially being received from a power source coupled to the computing device at 500. If not power is being received, the power component continues to detect if power is initially being received. If power is initially detected from the power source, the controller and/or the power application determine if a power button is accessed for a predetermined amount of time at 510. The controller and/or the power application can detect a user continues to touch and press the power button for a predetermined amount of time.

In one embodiment, if the power button is not accessed for the predetermined amount of time, the controller and/or the power application can proceed to load a BIOS and/or operating system of the computing device without disabling any features and the method can be complete. In another embodiment, if the power button is accessed for a predetermined amount of time, the controller and/or the power application can proceed to disable a power management feature of the computing device at 520. In one embodiment, the controller and/or the power application can disable a max power detect setting of the computing device. In other embodiments, the controller and/or the power application can further disable all non-default features of the computing device at 530.

As one or more features are disabled, the controller and/or the power application can instruct a display component to display a list of disabled features of the computing device at 540. The controller and/or the power application can then proceed to detect if a user has selected one or more features to re-enable at 550. If no feature has been selected to re-enable, the controller and/or the power application proceed to launch an operating system of the computing device and determine if the operating system was successfully launched at 580. In another embodiment, if the user selected one or more of the disabled features to re-enable, the controller and/or the power application proceed to re-enable the selected features at 560. The operating system is then launched with the re-enabled features at 570. The controller and/or the power application then determine if the operating system was successfully launched at 580.

If the operating system does not successfully launch, the controller and/or the power application can launch a diagnostic mode to identify and disable features which are restricting the operating system from launching at 590. The operating system can then be re-launched with the features disabled and the controller and/or the power application can determine if the operating system has successfully launched at 580. If the operating system successfully launches, the method is then complete. In other embodiments, the method of FIG. 5 includes additional steps in addition to and/or in lieu of those depicted in FIG. 5.

What is claimed is:

1. A computing device comprising:
a power component to couple with a power source and receive power;
a power logic module to detect if a power button of the computing device is accessed as the power component initially receives power from the power source; and
a controller to disable a feature of the computing device if the power button is accessed as the power component initially receives power from the power source.

2. The computing device of claim 1 wherein a feature of the computing device includes a max power mode specifying a threshold power level to be received by the power component before the computing device powers on.

3. The computing device of claim 1 wherein the controller disables the feature before a basic input/output system of the computing device is launched.

4. The computing device of claim 1 wherein a feature of the computing device includes at least one of an application, a service, a setting, a firmware, a driver, and a component of the computing device.

5. The computing device of claim 1 further comprising a display component to display a list of features of the computing device.

6. The computing device of claim 5 further comprising an input component to detect a user selecting a feature of the computing device to re-enable.

7. A method for managing features of a computing device comprising:
detecting if a computing device is initially receiving power from a power source coupled to the computing device;
detecting if a power button of the computing device is accessed as the computing device initially receives power; and
disabling a feature of the computing device if the power button is accessed as the computing device initially receives power from the power source.

8. The method for managing features of a computing device of claim 7 further comprising determining if the power button continues to be accessed for a predetermined amount of time before disabling a feature of the computing device.

9. The method for managing features of a computing device of claim 7 wherein disabling a feature of the computing device includes disabling a max power mode of the computing device.

10. The method for managing features of a computing device of claim 7 further comprising disabling the feature of the computing device before a basic input/output system of the computing device launches.

11. The method for managing features of a computing device of claim 7 further comprising enabling default features of the computing device.

12. The method for managing features of a computing device of claim 11 further comprising disabling features of the computing which are not default features.

13. The method for managing features of a computing device of claim 12 further comprising displaying a list of disabled features of the computing device and detecting a user select at least one feature to re-enable.

14. The method for managing features of a computing device of claim 13 further comprising launching an operating system of the computing device with the re-enabled features.

15. A non-volatile computer readable medium comprising instructions that if executed cause a controller to:
detect if a power component of a computing device is initially receiving power from a power source coupled to the power component;
detect if a power button of the computing device is accessed as the computing device initially receiving power; and
disable a feature of the computing device if the power button is accessed as the computing device initially receives power from the power source.

16. The non-volatile computer readable medium of claim 15 wherein the controller disables all non-default features of the computing device.

17. The non-volatile computer readable medium of claim 15 wherein the controller detects a user select a disabled feature to re-enable.

18. The non-volatile computer readable medium of claim 17 wherein the controller launches a diagnostic mode of the computing device if a basic input/output system (BIOS) or an operating system fails to launch with the feature re-enabled.

19. The non-volatile computer readable medium of claim 18 wherein the diagnostic mode identifies features of the computing device causing the BIOS or the operating system to fail to launch.

20. The non-volatile computer readable medium of claim 19 wherein the diagnostic mode disables features of the computing device causing the BIOS or the operating system to fad to launch.
